(19) United States
(12) Patent Application Publication
(10) Pub. No.: US 2011/0145258 A1
(43) Pub. Date: Jun. 16, 2011

(54) METHOD AND APPARATUS FOR TAGGING MEDIA ITEMS

(75) Inventor: Mikko KANKAINEN, Helsinki (FI)

(73) Assignee: Nokia Corporation, Espoo (FI)

(21) Appl. No.: 12/636,264

(22) Filed: Dec. 11, 2009

(51) Int. Cl. G06F 17/30; G06F 15/16

(52) U.S. Cl. 707/746; 707/E17.009; 707/E17.005; 707/E17.002; 707/770; 709/219

(57) ABSTRACT

An approach is provided for tagging media items based on spatiotemporal data. A request to tag a media item having spatiotemporal data is received, wherein the request corresponds to a user. A determination is made whether the spatiotemporal data satisfies a predetermined criterion, and a tag specified by another user is retrieved if the spatiotemporal data satisfies the predetermined criterion. The retrieved tag is then transmitted in response to the request.

### BACKGROUND

Users of camera ready cellular phones, digital cameras, video recorders and music players can only store so many items to the device's internal memory. Likewise, external storage mediums such as memory cards are limited in capacity, especially for those users with significant music files, pictures, video and other media in which they would like to access on demand. As a result, more people are using online or network based media storage services and applications to maintain their media items. These services allow a user to easily store, access, organize and even share their media items with other people. However, categorizing these media items, particular on mobile devices with small form factors, can be burdensome. Namely, users may be required to enter a description of the media, using a limited keyboard, for organizing the media and providing effective captions. Additionally, creating such descriptions for the categories can itself be challenging, thereby potentially discouraging users from uploading their media items.

### SOME EXAMPLE EMBODIMENTS

Therefore, there is a need for an approach to enable the most convenient and relevant tagging of media items.

According to one embodiment, a method comprises causing, at least in part, receipt of a request to tag a media item having spatiotemporal data, wherein the request corresponds to a user. The method also comprises determining whether the spatiotemporal data satisfies a predetermined criterion. The method further comprises retrieving a tag specified by another user if the spatiotemporal data satisfies the predetermined criterion, wherein the retrieved tag is associated with other spatiotemporal data. Still further, the method comprises causing, at least in part, transmission of the retrieved tag in response to the request.

According to another embodiment, an apparatus comprises at least one processor. The apparatus also comprises at least one memory including computer program code, the at least one memory and the computer program code configured to, with the at least one processor, cause the apparatus to perform at least the following: receipt of a request to tag a media item having spatiotemporal data, wherein the request corresponds to a user; determine whether the spatiotemporal data satisfies a predetermined criterion; retrieve a tag specified by another user if the spatiotemporal data satisfies the predetermined criterion, wherein the retrieved tag is associated with other spatiotemporal data; and initiate transmission of the retrieved tag in response to the request.

According to one embodiment, an apparatus comprises means for causing, at least in part, receipt of a request to tag a media item having spatiotemporal data, wherein the request corresponds to a user. The apparatus also comprises means for determining whether the spatiotemporal data satisfies a predetermined criterion. The apparatus also comprises means for retrieving a tag specified by another user if the spatiotemporal data satisfies the predetermined criterion, wherein the retrieved tag is associated with other spatiotemporal data. Still further, the apparatus also comprises means for causing, at least in part, transmission of the retrieved tag in response to the request.

According to another embodiment, a method comprises generating a request to tag a media item having spatiotemporal data, wherein the request corresponds to a user. The method also comprises causing, at least in part, transmission of the request to a media services platform. Moreover, the method comprises receiving, in response to the request, one or more tags, associated with another user, having spatiotemporal proximity to the spatiotemporal data of the media item. Still further, the method comprises selecting one of the received tags to tag the media item.

According to another embodiment, an apparatus comprises at least one processor. The apparatus also comprises at least one memory including computer program code, the at least one memory and the computer program code configured to, with the at least one processor, cause the apparatus to perform at least the following: generate a request to tag a media item having spatiotemporal data, wherein the request corresponds to a user; initiate transmission of the request to a media services platform; receive, in response to the request, one or more tags, associated with another user, having spatiotemporal proximity to the spatiotemporal data of the media item; and select one of the received tags to tag the media item.

According to yet another embodiment, an apparatus comprises means for generating a request to tag a media item having spatiotemporal data, wherein the request corresponds to a user. The apparatus also comprises means for causing, at least in part, transmission of the request to a media services platform. Moreover, the apparatus also comprises means for receiving, in response to the request, one or more tags, associated with another user, having spatiotemporal proximity to the spatiotemporal data of the media item. Still further, the apparatus also comprises means for selecting one of the received tags to tag the media item.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling the tagging of media items by a user based on spatiotemporal data associated with the media items of other users, according to one embodiment;

FIG. 2 is a diagram depicting the interaction between a media services platform and one or more users of user equipment (UE) in attendance at a common venue., according to one embodiment;

FIGS. 3a and 3b is a diagram of a media services interface configured to enable user tagging of media items, according to one embodiment;

FIGS. 4 and 5 are flowcharts of the process through which media items may be selectively tagged based on predetermined criterion, according to one embodiment;

FIGS. 6a and 6b are flowcharts of the process for tagging media items based on spatiotemporal data, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for enabling the convenient tagging of media items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

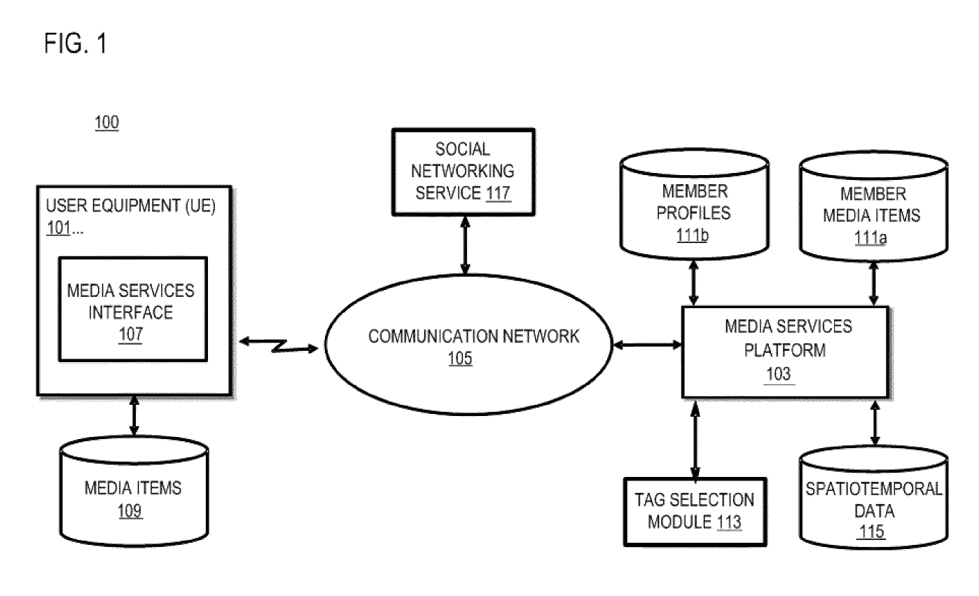

FIG. 1 is a diagram of a system capable of enabling the tagging of media items by a user based on spatiotemporal data associated with the media items of other users, according to one embodiment. As mentioned, the uploading of media has gained greater acceptance, as users are presented with the capability to capture media using various devices. By way of example, some popular social networking sites allow users to upload digital images to the site, categorize them, edit them and make them viewable by those with the appropriate access privileges (e.g., friends and family). The images can even be tagged, wherein the user is allowed to associate descriptive words with a particular image to make them searchable. Tags for a particular image are represented as a tag cloud in which more popular tags feature a larger text size. The popularity of a tag is generally based on the amount of times a particular tag is searched via an interface to the media storage service or social networking site, a prioritization assigned to it during tag creation or other criteria.

Unfortunately, tags that appear in a tag cloud tend to be more generic in nature as the user relies on commonly used words to describe the image. Moreover, as the same generic descriptive word is used to describe other images, the relevancy and popularity of a particular tag diminishes. The only alternative for the user is to enter new, more specific tags that describe the step, place, person, object or situation the image represents; a time consuming if not tedious undertaking, especially for those with a multitude of images.

Also, as used herein, the term “tag” refers to any descriptive word, phrase or combination thereof intended to provide a description of or relate to a particular media item. Tags may be associated with media items to enable them to be more readily searched or retrieved from a database. Furthermore, a user may engage in the process of “tagging” a particular media item, whereby they are assigning or creating a keyword or phrase to associate with a specific media item. It is contemplated that the spatiotemporal data for a particular media item desired to be tagged may be evaluated against a predetermined criterion to enable the automated selection, recommendation and/or assignment of tags to said media item. In this way, the amount of time and effort typically required on the part of the user in tagging one or more media items is significantly reduced while at the same time enhancing the likelihood that only the most relevant tags are assigned to the media item.

System 100 of FIG. 1, according to certain embodiments, provides a convenient approach to tag media items. As used herein, the term “media item” refers to any arrangement or combination of image, audio or video data capable of being processed—i.e., played or captured—by a media device. Exemplary media items may include, but are not limited to video recordings, audio recordings, and digital images including scanned representations of objects or combinations thereof. Media devices for capturing, storing, playing, rending or other forms of processing of said media items may include, but are not limited to a video recorder or player, digital camera, audio recorder or player (e.g., MP3 player), document presentment tool, etc. Various smart phones, Personal Digital Assistants (PDAs) and portable computing devices may also feature one or more of the above described media devices integrated therein. Although various embodiments are described with respect to imaging devices such as cameras, it is contemplated that the approach described herein may be used with any of the aforementioned devices.

As shown, the system 100 comprises a user equipment (UE) 101 having connectivity to a media services platform 103 via a communication network 105. Although only one UE 101 is depicted, it is contemplated that multiple UEs can be employed and concurrent obtain the services of the platform 103. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). Moreover, the UE 101 may execute one or more software applications or utilities, including but not limited to those for enabling or facilitating network access and communication, internet browsing, social networking, e-mail communication, file sharing and data transfer, word processing, data entry, spreadsheet processing, mathematical computation, etc. These applications and utilities may also be interoperable, so as to enable the execution of various features of the aforementioned application and utilities to be simultaneously executed to enable specific user tasks.

As an example, the UE 101 may have operable thereon a media services interface 107 for enabling it to exchange media items 109 over the network 105 with a media services platform 103. The media services interface 107 may be a dedicated media management application (e.g., a web service application), an internet browser from whence the user may establish a session with the media services platform 103 or the like. With respect to one embodiment, the media services interface 107 is a software application medium through which the user of the UE 101 can access media items 109 from, transmit media items 109 to or synchronize media items 109 between the media services platform 103 and the UE 101. As such, the media services interface 107 enables convenient transfer and storing of media items to the media services platform 103; an alternative to storing them to local memory or to physically connectable/removable storage modules (e.g., plug-n-play memory cards) available to the UE 101. In instances where the media services platform is directly executable upon the UE 101, however, the media services interface 107 enables direct interaction with local memory or physically connectable/removable storage modules associated with the UE 101.

In accord with the exemplary embodiment, the media services platform 103 is a network accessible application, hosted by a media services platform provider. The media services platform, according to one embodiment, is a hosted solution that enables a user to conveniently store, organize and share media items with other users having the proper access rights and permissions to the media services platform 103. As such, a user of UE 101 typically accesses the media services platform 103 through interface 107 via a registration and/or login process. This in turn enables profile information corresponding to the user to be created (for first time registration) or recalled (for subsequent login) from a member profiles database 111b—a database for maintaining profile information pertaining to the various registered or affiliated members (e.g., all users) of the media services platform 103. The profile may indicate, among other things, the name and contact details of the user, unique settings and preferences of the user, specific user interface options, file access and sharing right settings, etc.

In addition to the user profile, any media items belonging to or associated with the various registered or affiliated members of the media services platform 103 are maintained within a member media items 111a database. Generally, the media items 111a are maintained in association with a specific user profile, enabling only those media items related to the user in question to be accessed or recalled. Thus, for example, an image associated with the user of the UE 101 may be displayed in association with the user's profile data upon entry to the media services platform 103.

In the exemplary embodiment, the media services platform 103 also maintains spatiotemporal data 115 associated with each of the media items stored to the member media items database 111a. As used herein, the term “spatiotemporal data” refers to any data that conveys a particular moment in space and time for a particular object in question, i.e. a media item. Spatiotemporal data is often used in applications where understanding of an object's relative change in location, position or perspective from moment-to-moment is critical. This may include applications such as Geographic Information Systems (GIS), environmental data management systems and multimedia databases. For a media item, the spatiotemporal data includes at least a specific time stamp associated with the moment of capture of the media item and information relating the position and/or location of the media capture device at the moment of capture.

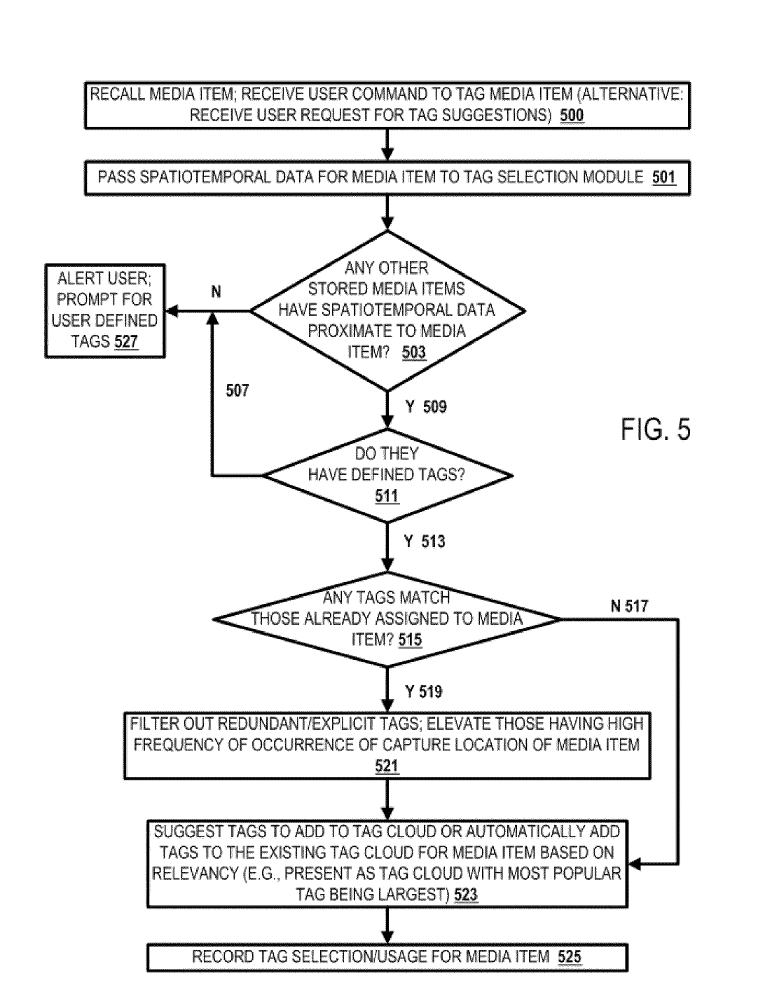

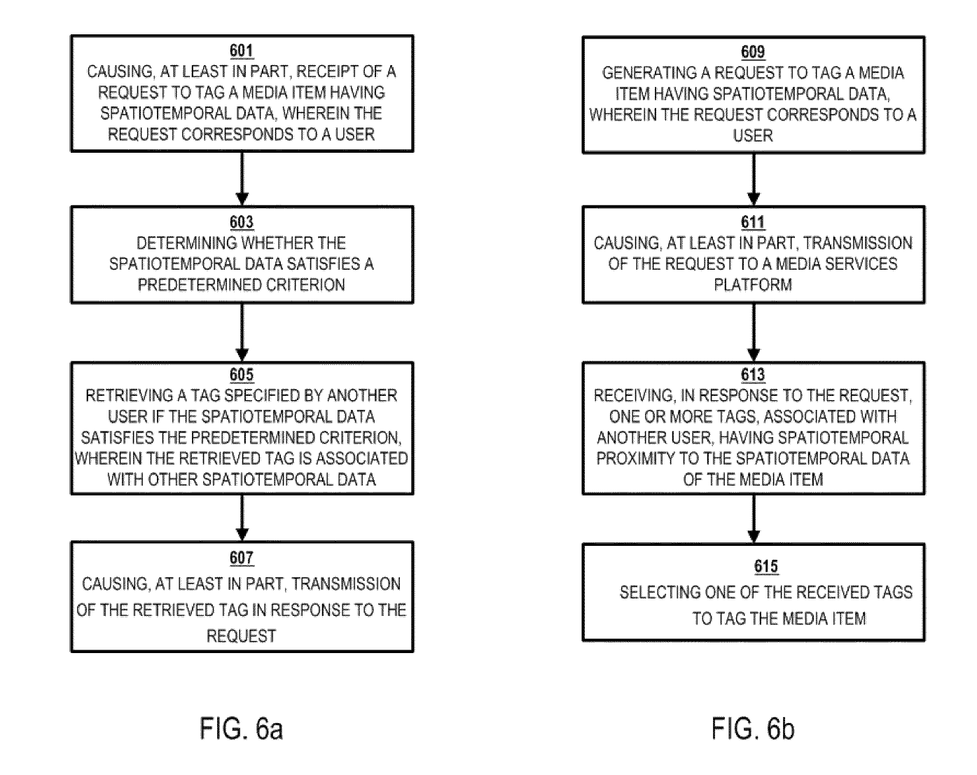

The spatiotemporal data 115 of a particular media item can be relayed to a tag selection module 113 also associated with the media services platform 103. In particular, the tag selection module 113 is an apparatus that is executable by, integrated with or operable in connection with the media services platform 103 for selecting, assigning or recommending to a user one or more tags to be associated with a media item in question. As will be discussed later with respect to FIGS. 5, 6a and 6b, the tag selection module analyzes spatiotemporal data of the media item in question relative to a predetermined criterion. This predetermined criterion may include a proximity threshold value—i.e., a range of acceptance of spatiotemporal proximity as measured in space and time—of the media item in question to that of other media items 111a. So, for example, the predetermined proximity can be based on a combination of a particular degree of longitudinal or latitudinal variance, radius or distance from a point of origin and an extent of time elapsed (a timeframe or variance). Spatiotemporal data within the range of applicability may then be used by the tag selection module 113 to identify and then inform the user of other tags that may also correspond to the media item in question. Means of calculating, measuring, formatting and representing spatiotemporal data may vary from one application to the next, and does not limit the scope of the exemplary embodiments presented herein.

Exemplary media services platforms 103 may include online content management services, file storage systems integral to other web-based applications, file sharing applications, or the like. Also, media services platforms 103 interact with a social networking service 117 (such as FACEBOOK or MYSPACE), where images, videos, documents or audio files are frequently shared between users on a permission only basis. In various implementations, the media services platform 103 may even be integrated within a particular user device, i.e., a cell phone, smartphone, PDA, etc.

In general, the media services interface 107 and the media services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

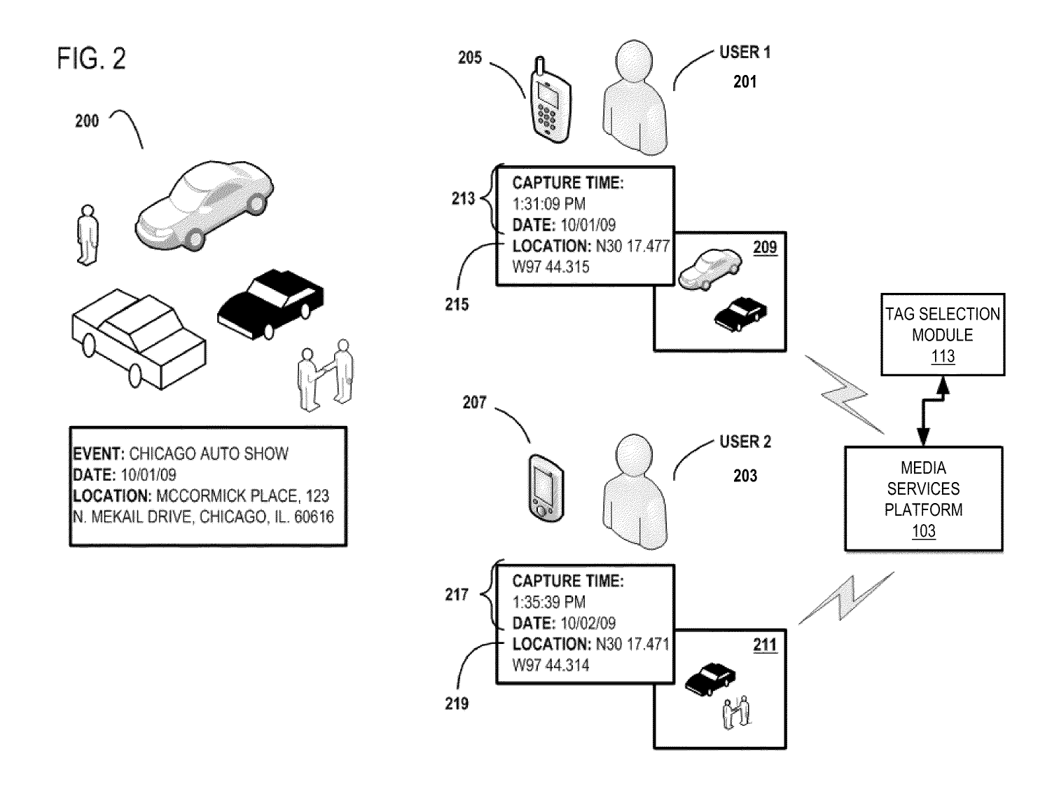

FIG. 2 is a diagram depicting the interaction between a media services platform and one or more users of user equipment (UE) as they attend a common venue. In certain embodiments, “common venue” refers a location, place, person, object, or premise in which users, e.g., user 1 201 and user 2 203, are positioned or located within relative proximity to the same location, place, person, object, or premise. The relative proximity of one user to the next with respect to a venue need not necessarily occur at the same time. In either case, the venue (e.g., step, object of interest) may be captured in one form or another by the user's respective user equipment 205 and 207. For example, each user 1 and 2 may capture an image 209 and 211 of common venue 200 respectively and store this image to their user equipment. Specifically, the common venue 200 for this example is the Chicago Auto Show, occurring on Oct. 1, 2009 through Oct. 3, 2009 at McCormick Place, located at 123 N. Mekail Drive, Chicago, Ill. 60616. It will be recognized that this particular address corresponds to a specific set of geographic coordinates, information that when processed with respect to specific time data is necessary for generating spatiotemporal data.

User 1 captures an image 209 of the venue at a time of 1:31:09 pm on date Oct. 1, 2009. This creates metadata, such as a timestamp 213, in association with the image 209, which is generally stored locally to the user equipment 205 along with the image. Also, assuming the media capture device (user equipment 205) in this case is an image ready cell phone, Smartphone or GIS enabled Personal Digital Assistant, the location in space of the user equipment 205 at the moment of capture is also recorded. In this example, location 215 corresponds to global coordinates expressed in a minutes/decimal format, where the longitude is N30 17.477 and latitude is W97 44.315.

Alternatively, the metadata associated with the image may be provided by other applications or integrated devices within the user's equipment, such as a calendar application, voice recorder application, video capture device, infrared (IR) sensing device or the like. For example, when capturing the image 209, the tag selection module 223 can enable the user to choose whether to associate metadata for a particular calendar with the captured image. In this case, the calendar metadata may include time interval data, time of calendar event capture or logging and perhaps venue name (e.g., Auto Show), associated contacts, guest speakers, and meeting location data. Location either could be taken from the calendar item or added directly based on location information detected by any sensor capabilities by the device—i.e., IR, internal antennae. Generally, any information may be useful as metadata, including communication data exchanged between the user and said user's colleagues pertaining to and during the time of the venue. Thus, chat, e-mail, text, user group messaging, conference calling or any other communication data relayed or generated during the venue may be useful in connection with the spatiotemporal data.

Similarly, user 2 also captures an image 211 of the same venue 200 at a time of 1:35:39 pm on Oct. 2, 2009, a day after the moment of capture of user 1. Through one or more of the aforementioned procedures, this results in the creation of a timestamp 217 in association with the image 211, which is generally stored locally to the user equipment 207 along with the image. Also, assuming the media capture device (user equipment 207) in this case is an image ready cell phone, Smartphone or GIS enabled Personal Digital Assistant, the location in space of the user equipment 205 at the moment of capture is also recorded. In this example, location 219 corresponds to global coordinates expressed in a minutes/decimal format, where the longitude is N30 17.471 and latitude is W97 44.314. The location of image capture for user 2 varies, albeit slightly, from that of user 1. This accounts for the seemingly different perspectives of venue 200 as captured in images 209 and 211. Though captured on different days and times from relatively different positions or locations, images 209 and 211 are of the same venue.

Although the above scenario is described with respect to the use of images, it is contemplated that any type of media may be utilized—e.g., audio, video, etc.

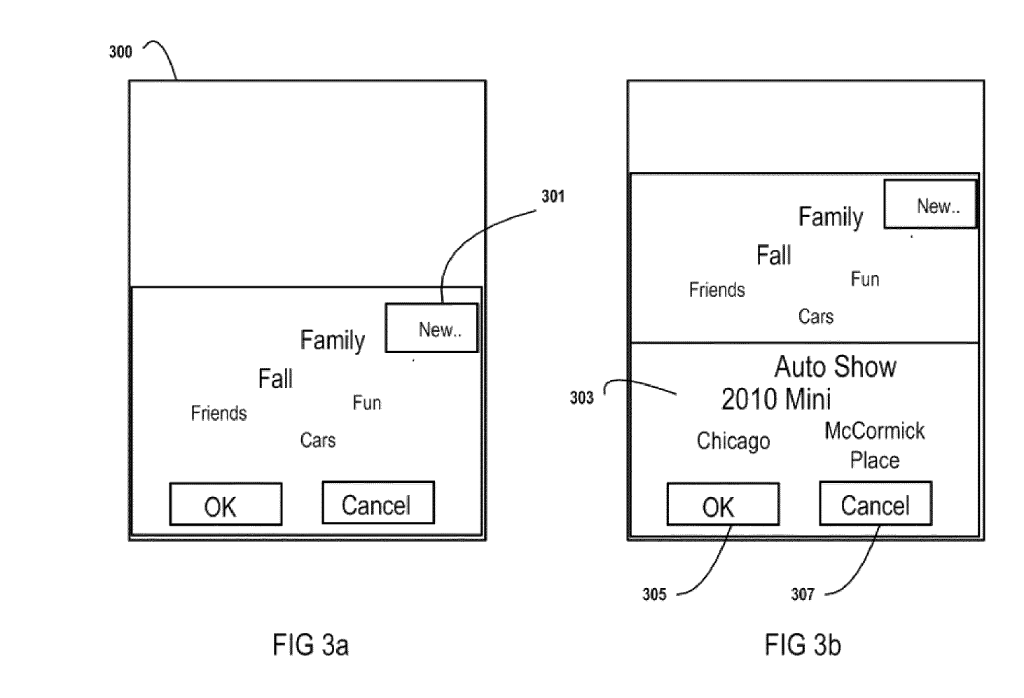

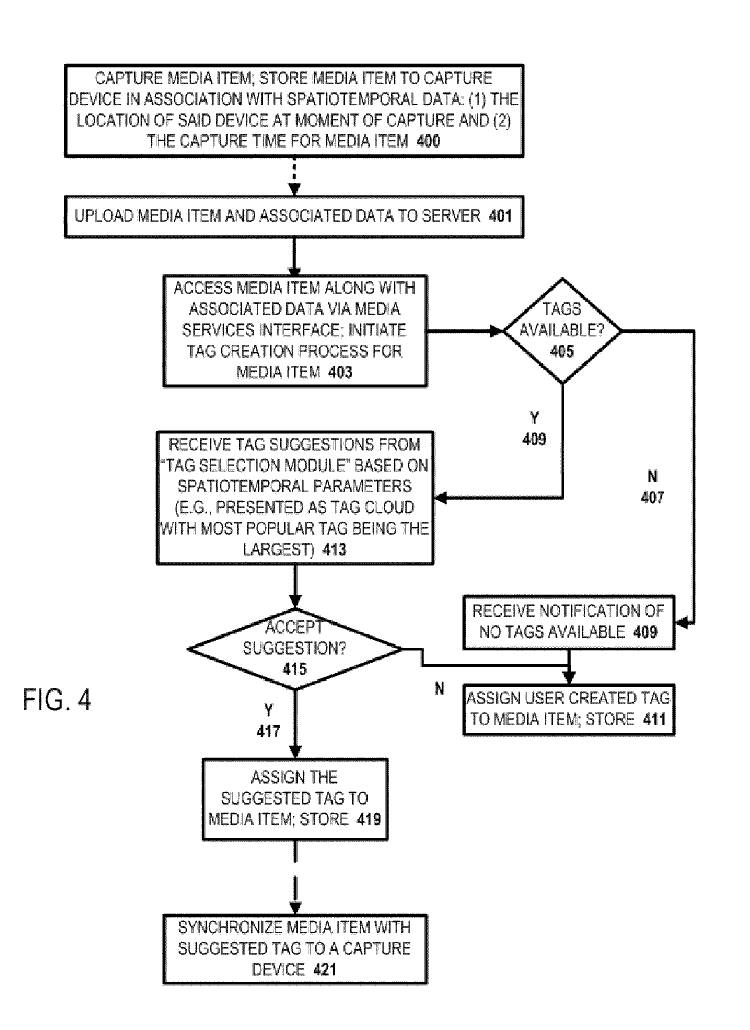

Reference is now made to FIGS. 3a and 3b, which depicts a media services interface configured to enable user tagging of media items, according to one embodiment. The description also proceeds with FIGS. 4 and 5, flowcharts of the process through which media items may be selectively tagged based on predetermined criterion, according to one embodiment. Ideally, in accord with an exemplary embodiment, tags generated for at least one of the images of a common venue should inform the selection or assignment of tags to be used for subsequently tagged images. For the purposes of explanation, it is assumed that while the steps performed in FIGS. 4 and 5 are identical for both users 1 and 2, the procedures are performed at separate times. Given that image 209 was captured first, it is assumed that it was stored and tagged by user 1 prior to the tagging of image 211 by user 2. Tags assigned to the image 211 include Auto Show, 2010 Mini, Chicago and McCormick Place. Indeed, as the frequency of images from other users associated with the same venue increases, the relevancy of the tags also increases.

Having captured image data 211 in conjunction with its spatiotemporal data 217/219, user 2 subsequently uploads the image 211 from the user equipment 207 to the media services platform 103. The timestamp 217 and location data 219 associated with each image is also sent to the media services platform 103. The aforementioned steps correspond to steps 400 and 401 of FIG. 4. Once uploaded, user 2 may access image 211 (e.g., media item 1) from the media services platform 103 via a media services interface 300, shown in FIGS. 3a-b. The interface 300 may be executed via the user equipment 207 employed by user 2 to capture the image or other user equipment. From the interface 300, user 2 may initiate a new tagging process or review the current tags as assigned (e.g., by the user) to the image thus far. As shown in FIG. 3, the current tags are Family, Fall, Friends, Fun and Cars, with Family and Fall being presented more prominently to represent their particular popularity. Generally, presentment of a collection of tags in a manner of varying prominence or format relative to a specific media item is referred to as a tag cloud. Of course, any means by which the associated tags are presented is within the scope of the embodiments herein. To enable the addition of tags to the existing collection (or tag cloud), the user initiates a tagging process by selecting the “New” button 301. This corresponds to step 403 of FIG. 4.

Selection of the “New” button 301 results in the transmission of a user request to receive tag suggestions from the tag selection module of the media services platform (step 500). Upon receipt of the request, the spatiotemporal data associated with the image is then passed along to the tag selection module, and analyzed to determine if it is within a predetermined spatiotemporal proximity of other images (steps 501 and 503 respectively). In the case of images 207 and 211 for example, the predetermined criteria may include an acceptable time variance (e.g., 3 days) and location variance (e.g., ± latitude/longitude) that clearly recognizes the spatiotemporal relationship between the two.

A check is also performed to determine whether those meeting the predetermined criterion (step 509) have any tags associated therewith (step 511). When the predetermined criterion is not met (step 505), or no tags are defined in association with those images that meet the spatiotemporal criterion (step 507), the requesting user 2 is alerted that no suggestions are forthcoming and/or prompted to enter user defined tags (step 527). This corresponds also to step 405 of FIG. 4, where if no tags are provided by the tag selection module (step 407) to USER 2 via the media services interface 300, the user is notified and prompted to create their own tags (steps 409 and 411).

Alternatively, if the predetermined criterion is met and tags are defined for those images (steps 503, 509-513), the tag selection module 113 performs an additional analysis (step 515) to determine if any of the identified tags match those already associated with the image in question. For example, with reference again to FIG. 3a, if any of the tags suggested by the tag selection module 113 were to include Family, Fall, Friends, Fun and Cars, these tags would be filtered out—i.e., not presented to the user as a suggestion. Of the remaining suggestions, if any were: (1) designated as a community tag in advance, such as by the operator of a venue for which the image to be tagged is associated; or (2) associated with a common or high frequency location respective to the venue, these tags may be automatically assigned to the image in question and/or elevated (featured more prominently) in the tag cloud (steps 519 and 521). In the latter case, high frequency of occurrence of a particular location corresponding to that of the venue as imaged, suggests the venue is a commonly known (static) landmark, object or place. As such, these tags are suggested irrespective of temporal data as a matter of user convenience.

In one embodiment, the tags that are provided by the tag selection module 113 can be predetermined, for instance, by the operator or promoter of the venue. That is, under the scenario involving the Auto Show, the promoter can supply tags that pertains to the categories of cars: e.g., luxury cars, exotic cars, etc. In the hosted solution embodiment, the service provider that maintains the media services platform 103 can arrange to disseminate these tags, and in turn, for example, supply the recipients of these tags information (e.g., web address, etc.) about the venue or other events of the promoter. As yet another consideration, the tag can be associated with the image based on an identified social networking group the user belongs to. For example, if the user is affiliated with the social networking group (e.g., auto enthusiasts club), the tag selection module may be configured to acquire tags associated with this particular social networking group. Tags provided may be based on the spatiotemporal data indicated.

Having met the predetermined criterion (step 413), the tags Auto Show, 2010 Mini, Chicago and McCormick Place associated with previously tagged image 209 are presented to USER 2 via the media services interface 303 (step 413). Again, the tags deemed most popular i.e., high frequency of selection relative to the venue in question, or most relevant to the venue, are featured more prominently. The user can accept or reject the suggested tags (step 415), collectively or individually, by pressing the “OK” or “Cancel” buttons 305 and 307 respectively. If the user accepts, the suggested tags are added to the tag cloud associated with the image (steps 417 and 419). Subsequently, the user may synchronize their media items (e.g., images) stored on the user equipment with the newly tagged instances of the image as maintained by the media services platform (step 421). The media services platform may also record the newly formed tags associated with the image (step 525).

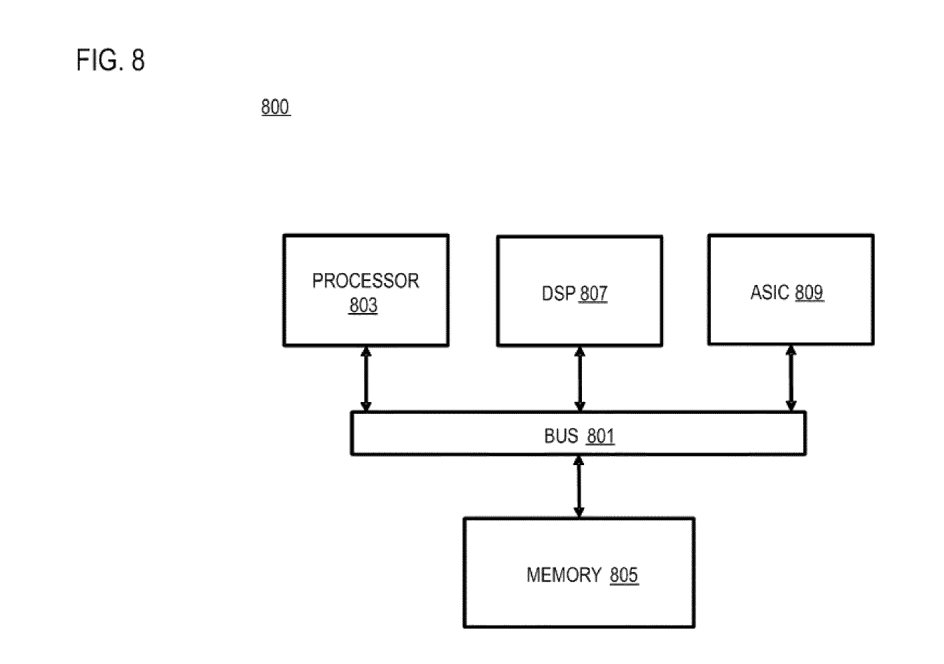

FIGS. 6a and 6b are flowcharts of the process for tagging media items based on spatiotemporal data, according to one embodiment. In one embodiment, the tag selection module 113 performs the process 600 and is implemented in, for instance, a chip set including a processor and a memory as shown FIG. 8. In step 601, the process entails causing, at least in part, receipt of a request to tag a media item having spatiotemporal data, wherein the request corresponds to a user. In step 603, the process entails determining whether the spatiotemporal data satisfies a predetermined criterion. In steps 605 the process entails retrieving a tag specified by another user if the spatiotemporal data satisfies the predetermined criterion, wherein the retrieved tag is associated with other spatiotemporal data. Finally, in step 607 the process entails causing, at least in part, transmission of the retrieved tag in response to the request

In step 609 of FIG. 6a entails generating a request to tag a media item having spatiotemporal data, wherein the request corresponds to a user. In step 611 the process entails causing, at least in part, transmission of the request to a media services platform. In step 613, the process entails receiving, in response to the request, one or more tags, associated with another user, having spatiotemporal proximity to the spatiotemporal data of the media item. Finally, step 615 entails selecting one of the received tags to tag the media item.

The described processes and arrangement, according to certain embodiments, advantageously provide users with a convenient approach to tagging their media items, using more relevant tags. Also, the approach encourages the uploading of media items by the users so that they can avail themselves of community tags. From the perspective of the media services platform provider, the approach encourages increased ease of data collaboration. In other embodiments, the tag selection module may mark each tag with the device identifier of the capture device, so as to enable the media services platform 103 to uniquely identify the origin of designated tags. As a result, the media services platform 103 may readily employ policies for authenticating and validating tags. For example, the device data can later be utilized for identifying and subsequently addressing a user whose tags include improper or false information (e.g., foul language). Or, in yet another alternative embodiment, the authenticity or applicability of a tag to a particular image can be verified, and the creator of the tag or image can be reconciled accordingly by tracing back to the user via the device identifier. If a tag entitled “Rock Concert” is submitted for an image conveying an unwanted sales solicitation, the image and/or tag originator may be alerted, warned or even restricted for further access to the system.

The processes described herein for tagging media items based on spatiotemporal data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

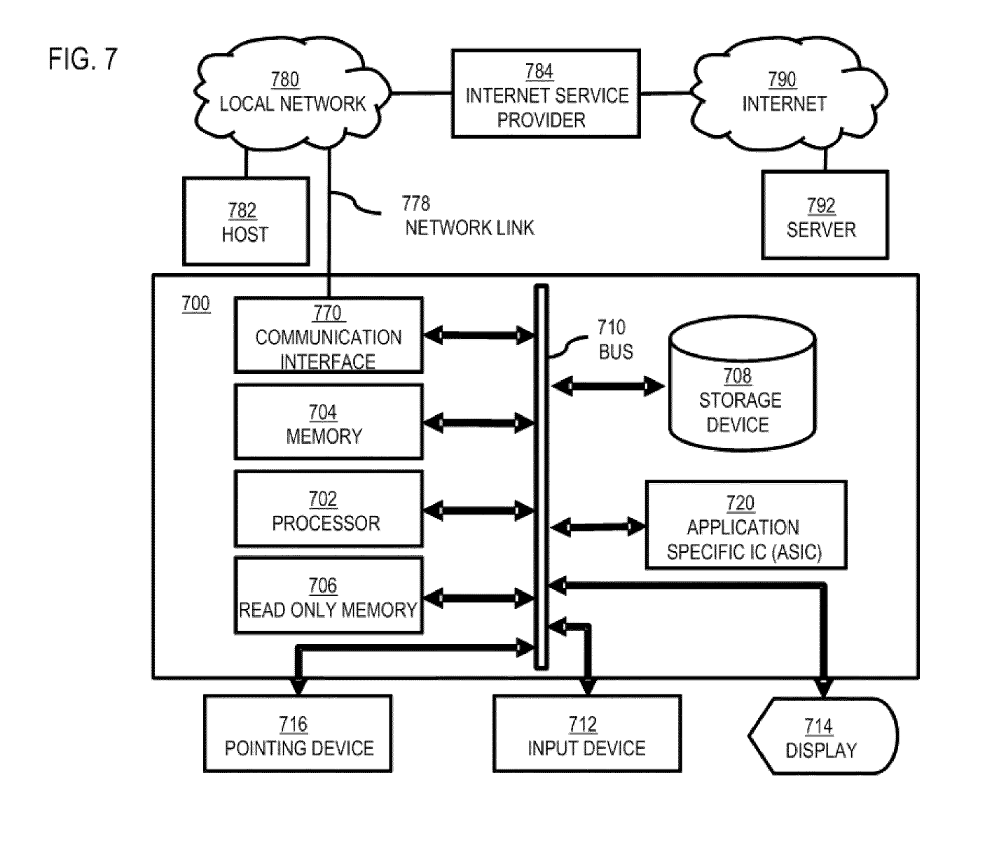

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) tag media items based on spatiotemporal data as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of tagging media items based on spatiotemporal data.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related tag media items based on spatiotemporal data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions tagging media items based on spatiotemporal data. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions tagging media items based on spatiotemporal data, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for tagging media items via UE 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to tag media items as described herein and includes, for instance, the processor and memory components described with respect to FIG. *˜incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of tagging media items based on spatiotemporal data.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to tag media items based on spatiotemporal data. The memory 805 also stores the data associated with or generated by the execution of the inventive steps.

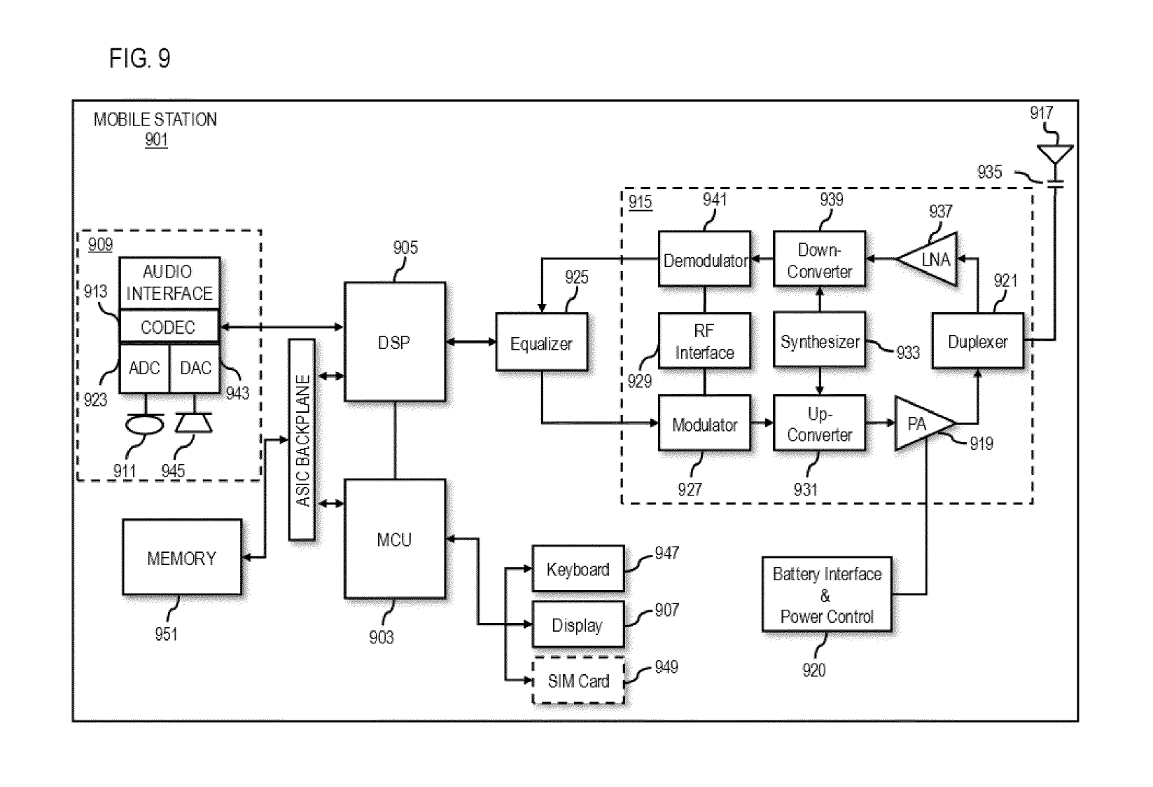

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of tagging media items based on spatiotemporal data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of tagging media items based on spatiotemporal data. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to tag media items based on spatiotemporal data. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
causing, at least in part, receipt of a request to tag a media item having spatiotemporal data, wherein the request corresponds to a user;
determining whether the spatiotemporal data satisfies a predetermined criterion;
retrieving a tag specified by another user if the spatiotemporal data satisfies the predetermined criterion, wherein the retrieved tag is associated with other spatiotemporal data; and
causing, at least in part, transmission of the retrieved tag in response to the request.

2. A method of claim 1, further comprising:
causing, at least in part, receipt of another tag;
associating the other tag with spatiotemporal data; and
causing, at least in part, storage of the other tag among a plurality of tags.

3. A method of claim 2, further comprising:
designating the other tag as a community tag to be provided as a suggestion for tagging of another media item.

4. A method of claim 2, further comprising:
designating the other tag as an elevated tag to be provided as a suggestion for tagging of another media item irrespective of temporal data.

5. A method of claim 1, wherein the predetermined criterion specifies a proximity threshold value.

6. A method of claim 1, further comprising:
generating a list of popular tags as a suggestion for another media item having a particular spatiotemporal data.

7. A method of claim 1, further comprising:
causing, at least in part, storage of a plurality of tags specified by an operator of a venue, wherein one or more of the tags specified by the operator are provided as a suggestion to another media item if spatiotemporal data of the other media item satisfies the predetermined criterion with respect to the venue.

8. An apparatus comprising:
at least one processor; and
at least one memory including computer program code,
the at least one memory and the computer program code configured to, with the at least one processor, cause the apparatus to perform at least the following:
receive a request to tag a media item having spatiotemporal data, wherein the request corresponds to a user;
determine whether the spatiotemporal data satisfies a predetermined criterion;
retrieve a tag specified by another user if the spatiotemporal data satisfies the predetermined criterion, wherein the retrieved tag is associated with other spatiotemporal data; and
initiate transmission of the retrieved tag in response to the request.

9. An apparatus of claim 8, wherein the apparatus is further caused, at least in part, to:
receive another tag;
associate the other tag with spatiotemporal data; and
store the other tag among a plurality of tags.

10. An apparatus of claim 9, wherein the apparatus is further caused, at least in part, to:
designate the other tag as a community tag to be provided as a suggestion for tagging of another media item.

11. An apparatus of claim 9, wherein the apparatus is further caused, at least in part, to:
designate the other tag as an elevated tag to be provided as a suggestion for tagging of another media item irrespective of temporal data.

12. An apparatus of claim 8, wherein the predetermined criterion specifies a proximity threshold value.

13. An apparatus of claim 8, wherein the apparatus is further caused, at least in part, to:
generate a list of popular tags as a suggestion for another media item having a particular spatiotemporal data.

14. An apparatus of claim 8, wherein the apparatus is further caused, at least in part, to:
store of a plurality of tags specified by an operator of a venue, wherein one or more of the tags specified by the operator are provided as a suggestion to another media item if spatiotemporal data of the other media item satisfies the predetermined criterion with respect to the venue.

15. A method comprising:
generating a request to tag a media item having spatiotemporal data, wherein the request corresponds to a user;
causing, at least in part, transmission of the request to a media services platform;
receiving, in response to the request, one or more tags, associated with another user, having spatiotemporal proximity to the spatiotemporal data of the media item; and
selecting one of the received tags to tag the media item.

16. A method of claim 15, further comprising:
causing, at least in part, capture of another media item having spatiotemporal data;
generating a new tag corresponding to the other media; and
causing, at least in part, uploading of the other media and the new tag to the media services platform for sharing the new tag.

17. A method of claim 15, further comprising:
causing, at least in part, capture of another media item having spatiotemporal data;
causing, at least in part, receipt of a list of popular tags as a suggestion for the other media item.

18. An apparatus comprising:
at least one processor; and
at least one memory including computer program code, the at least one memory and the computer program code configured to, with the at least one processor, cause the apparatus to perform at least the following,
generate a request to tag a media item having spatiotemporal data, wherein the request corresponds to a user;
initiate transmission of the request to a media services platform;
receive, in response to the request, one or more tags, associated with another user, having spatiotemporal proximity to the spatiotemporal data of the media item; and
select one of the received tags to tag the media item.

19. An apparatus of claim 18, wherein the apparatus is further caused, at least in part, to:
capture of another media item having spatiotemporal data;
generate a new tag corresponding to the other media; and
upload of the other media and the new tag to the media services platform for sharing the new tag.

20. An apparatus of claim 18, wherein the apparatus is further caused, at least in part, to:
capture of another media item having spatiotemporal data; and
receive of a list of popular tags as a suggestion for the other media item.
